(19) United States
(12) Patent Application Publication
(10) Pub. No.: US 2008/0112622 A1
(43) Pub. Date: May 15, 2008

(54) SKIN DETECTION SYSTEM AND METHOD

(75) Inventors: Boo Dong KWAK, Suwon (KR); Bong Soon Kang, Pusan (KR); Jeong Uk Im, Masan (KR); Joo Young Ha, Changwon (KR); Won Tae Choi, Yongin (KR); Kang Joo Kim, Suwon (KR); Tae Eung Kim, Yongin (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD, GYUNGGI-DO (KR)

(21) Appl. No.: 11/877,273

(22) Filed: Oct. 23, 2007

(30) Foreign Application Priority Data
Nov. 13, 2006 (KR) 10-2006-0111659

(51) Int. Cl. G06K 9/46

(52) U.S. Cl. 382/190

(57) ABSTRACT

Provided is a skin detection system including a first skin region detecting unit that detects a region included in a first skin region from an image signal applied from outside, the first skin region represented by the distribution of sampled human skins; a second skin region detecting unit that detects a region included in a second skin region, where a human skin region is set, from the image signal; and a skin region processing unit that, when a region included in both of the first and second skin regions is detected, determines the region as a human skin region so as to extract the detected skin region.

### CROSS-REFERENCE TO RELATED APPLICATIONS

This application claims the benefit of Korean Patent Application No. 10-2006-0111659 filed with the Korea Intellectual Property Office on Nov. 13, 2006, the disclosure of which is incorporated herein by reference.

### BACKGROUND OF THE INVENTION

1. Field of the Invention

The present invention relates to a skin detection system and method, which detects a human skin region included in an image signal by using a YCbCr color space.

2. Description of the Related Art

With the rapid development of digital cameras and mobile phones, a person transmits his/her still or moving image, taken by a digital camera or mobile phone, to another person through a wireless communication.

In this case, the figure of the person may be included in the still or moving image. However, when the skin color of the person is changed in the image, the image quality of the image is significantly degraded. Further, when the degradation of image quality occurs in a camera used in an airport, a harbor, or a company which requires security and observation, the reliability of the camera may decrease.

To solve such a problem, a method has been adopted, in which an applied image signal is compared with face contour sample data so as to detect a face contour included in the image signal. In the face contour sample data, face contour data obtained by collecting various types of face contours are stored.

Hereinafter, a conventional system for detecting a face contour will be described with reference to FIG. 1.

FIG. 1 is a block diagram of a conventional system for detecting a face contour.

As shown in FIG. 1, the system includes a face contour comparing unit 110, a face contour storing unit 120, and a face contour detecting unit 130.

The face contour storing unit 120 stores face contour sample data which are obtained by collecting various types of faces contours to convert into data. In the face contour sample data, various types of face contours such as an oval face shape, a circular face shape, a rectangular face shape and so on are stored.

The face contour comparing unit 110, which is connected to the face contour storing unit 120 and the face contour detecting unit 130, receives an image signal S from outside and then compares the image signal S with the face contour sample data stored in the face contour storing unit 120.

The face contour detecting unit 130 is connected to the face contour comparing unit 110 and serves to detect a face contour, which is included in the face contour sample data, from the image signal S compared by the face contour comparing unit 110.

At this time, the face contour detecting unit 130 compares the image signal S with all the face contours stored in the face contour sample data one by one, and then detects an identical face contour to the face contour sample data.

Hereinafter, a conventional method for detecting a face contour using the system of FIG. 1 will be described with reference to FIG. 2.

FIG. 2 is a flow chart sequentially showing a conventional method for detecting a face contour.

First, as shown in FIG. 2, an image signal applied from outside is compared with the face contour sample data in which various types of face contours are stored (step S201).

Then, it is checked whether a face contour is included in the compared image signal or not (step S202).

At this time, when a face contour is not included in the image signal, the image signal is output as it is, without being processed.

Otherwise, when a face contour is included in the image signal, the face contour included in the image signal is detected, and the other region excluding the face contour is converted into a block color. Then, the image signal is output (step S203).

As described above, the conventional system and method for detecting a face contour compares an image signal with the face contour sample data, in which various types of face contours are stored, and detects a face contour included in the image signal.

In the conventional system and method, however, the face contour sample data does not include all types of face contours which can cover a generation and sex. Therefore, it is difficult to accurately detect a face contour included in an image signal.

Further, since the face contour sample data includes a large volume of data, the face contour storing unit 120 for storing the face contour sample data should be separately provided. Therefore, when the face contour storing unit 120 is mounted on a device such as a mobile phone or the like, the size of the device inevitably increases.

Further, since the image signal should be compared with the face contours stored in the face contour sample data one by one, it takes a long time to detect a face contour.

### SUMMARY OF THE INVENTION

An advantage of the present invention is that it provides a skin detection system and method, which detects a human skin region included in an image signal by using a YCbCr color space.

Additional aspects and advantages of the present general inventive concept will be set forth in part in the description which follows and, in part, will be obvious from the description, or may be learned by practice of the general inventive concept.

According to an aspect of the invention, a skin detection system comprises a first skin region detecting unit that detects a region included in a first skin region from an image signal applied from outside, the first skin region represented by the distribution of sampled human skins; a second skin region detecting unit that detects a region included in a second skin region, where a human skin region is set, from the image signal; and a skin region processing unit that, when a region included in both of the first and second skin regions is detected, determines the region as a human skin region so as to extract the detected skin region.

Preferably, the first skin region detecting unit includes a first skin region storing section which stores the range of the first skin region; and a first skin region detecting section which detects a region included in the first skin region from the image signal.

Preferably, when a region included in the first skin region is not detected from the image signal, the first skin region detecting section processes the image signal into a black color and then outputs the processed image signal. At this time, the first skin region detecting section converts the Y, Cb, and Cr components of the image signal into 0, 128, and 128, respectively.

Preferably, the second skin region detecting unit includes a second skin region setting section which selects any one option from a plurality of options, in which the range of the second skin region is set in advance, and then sets the range of the second skin region; and a second skin region detecting section which detects a region included in the set second skin region from the image signal.

Preferably, when a region included in the second skin region is not detected from the image signal in which the first skin region is detected, the second skin region detecting section processes the image signal into a black color and then outputs the image signal. At this time, the second skin region detecting section converts the Y, Cb, and Cr components of the image signal into 0, 128, and 128, respectively.

Preferably, the skin region processing unit processes the other region excluding the detected skin region into a black color. At this time, the skin region processing unit converts the Y, Cb, and Cr components of the other region excluding the detected skin region into 0, 128, and 128, respectively.

Preferably, the skin detection system further comprises a white region processing unit that is connected to the second skin region detecting unit and the skin region processing unit, and when the skin region is detected, processes a white region included in the detected skin region.

Preferably, the white region processing unit includes a white region setting section which selects any one option among a plurality of options, in which the range of the white region is set in advance, so as to set the range of the white region; and a white region processing section which processes a region of the detected skin region included in the white region.

Preferably, when a region included in the white region is detected from the detected skin region, the white region processing section processes the detected white region into a black color. At this time, the white region processing section converts the Y, Cb, and Cr components of the detected white region into 0, 128, and 128, respectively.

According to another aspect of the invention, a skin detection method comprises the steps of: (a) selecting an option of skin sample data, which is obtained by sampling human skins, so as to detect a human skin; (b) receiving an image signal from outside; (c) comparing the image signal with the skin sample data; and (d) when a skin region included in the skin sample data is detected from the compared image signal, extracting the detected skin region.

Preferably, the skin sample data obtained by sampling human skins is composed of first and second skin regions.

Preferably, in step (a), any one option among a plurality of options, where the range of the second skin region is set in advance, is selected so as to set the range of the second skin region.

Preferably, when a region included in the first skin region is not detected from the image signal compared in step (c), the image signal is processed into a black color and is then output. At this time, the Y, Cb, and Cr components of the image signal are converted into 0, 128, and 128, respectively.

Preferably, when a region included in the second skin region is not detected from the image signal compared in step (c), the image signal is processed into a black color and is then output. At this time, the Y, Cb, and Cr components of the image signal are converted into 0, 128, and 128, respectively.

Preferably, when a skin region included in both of the first and second skin regions is detected from the image signal in step (d), the other region excluding the detected skin region is processed into a black color. At this time, the Y, Cb, and Cr components of the other region excluding the detected skin region are converted into 0, 128, and 128, respectively.

Preferably, the skin detection method further comprises the step of setting a white region processing option for processing the white region of the skin region included in the skin sample data in step (a).

Preferably, in step (a), any one option among a plurality of options, where the range of the white region is set in advance, is selected so as to set the range of the white region.

Preferably, when the white region processing option is selected in step (a), the white region of the detected skin region is processed into a black color in step (d). At this time, the Y, Cb, and Cr components of the white region of the detected skin region are converted into 0, 128, and 128, respectively.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional system for detecting a face contour;

FIG. 2 is a flow chart sequentially showing a conventional method for detecting a face contour;

FIG. 3 is a block diagram of a skin detection system according to the present invention;

FIG. 4A is a diagram showing Cb-Cr distribution of the sampled skins of the black race;

FIG. 4B is a diagram showing Cb-Cr distribution of the sampled skins of the yellow race;

FIG. 4C is a diagram showing Cb-Cr distribution of the sampled skins of the white race;

FIG. 4D is a diagram showing Cb-Cr distribution of the skins of every race using FIGS. 4A to 4C;

FIGS. 5A and 5B are graphs showing a first skin region using skin sample data according to the invention;

FIG. 6 is a diagram showing a second skin region E according to the invention.

FIG. 7A is a graph showing a skin region including both the first and second skin regions;

FIG. 7B is a graph showing a white region in FIG. 7A;

FIG. 8 is a flow chart sequentially showing a skin detection method according to the invention; and

FIG. 9 is a flow chart sequentially showing the skin detection method in more detail.

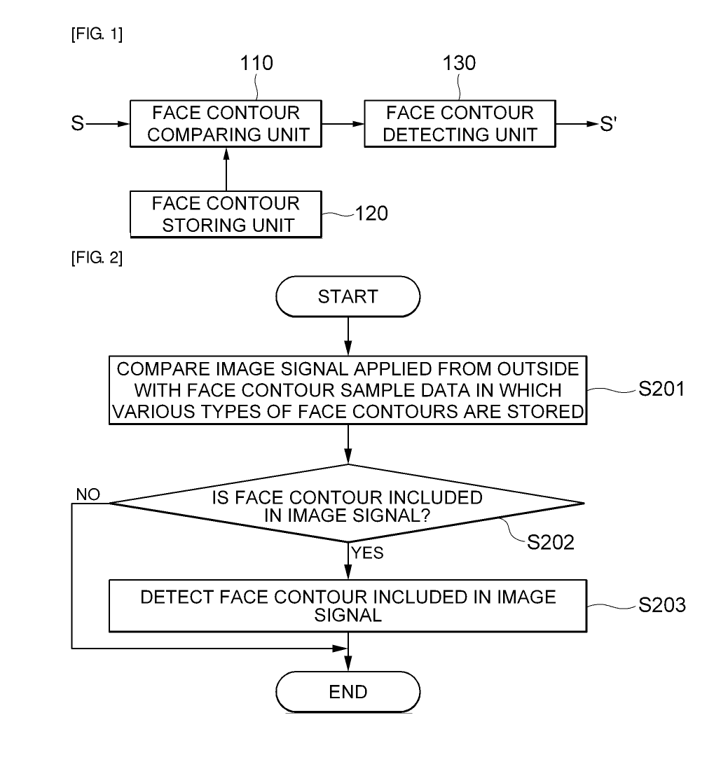

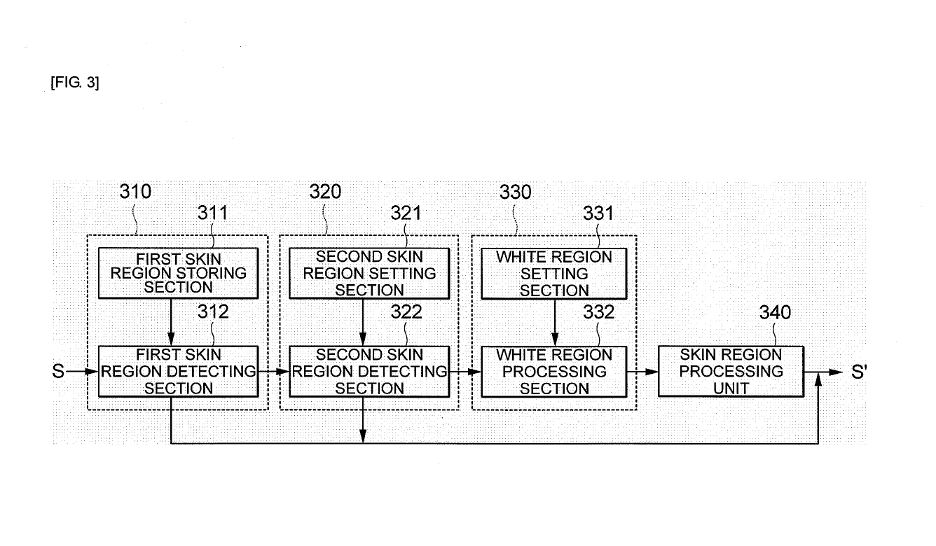

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, embodiments of the present invention will be described in detail with reference to the accompanying drawings.

Skin Detection System

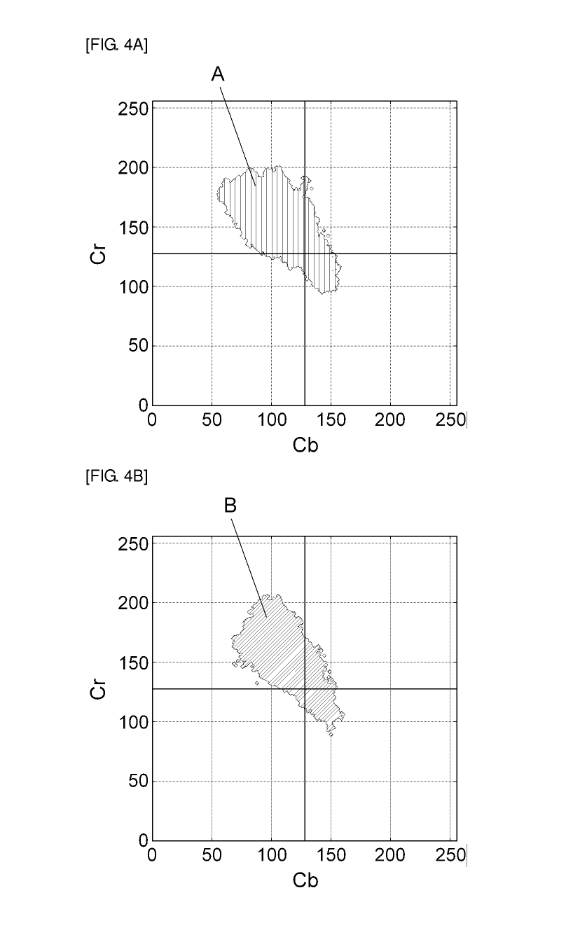

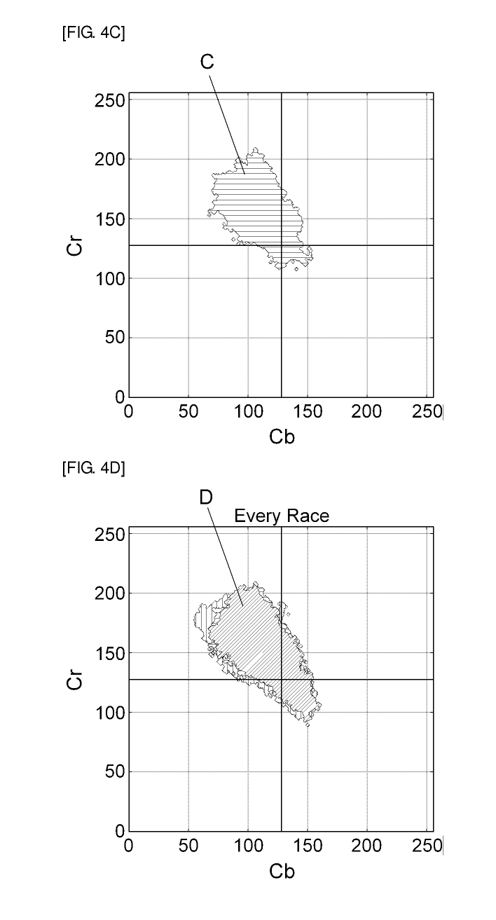

FIG. 3 is a block diagram of a skin detection system according to the present invention. FIG. 4A is a diagram showing Cb-Cr distribution of the sampled skins of the black race. FIG. 4B is a diagram showing Cb-Cr distribution of the sampled skins of the yellow race. FIG. 4C is a diagram showing Cb-Cr distribution of the sampled skins of the white race. FIG. 4D is a diagram showing Cb-Cr distribution of the skins of every race using FIGS. 4A to 4C.

As shown in FIG. 3, the skin detection system according to the invention includes a first skin region detecting unit 310, a second skin region detecting unit 320, and a skin region processing unit 340.

The first skin region detecting unit 310 includes a first skin region storing section 311 and a first skin region detecting section 312 and serves to detect a region included in a first skin region, which is represented by the distribution of sampled human skins, from an image signal S applied from outside.

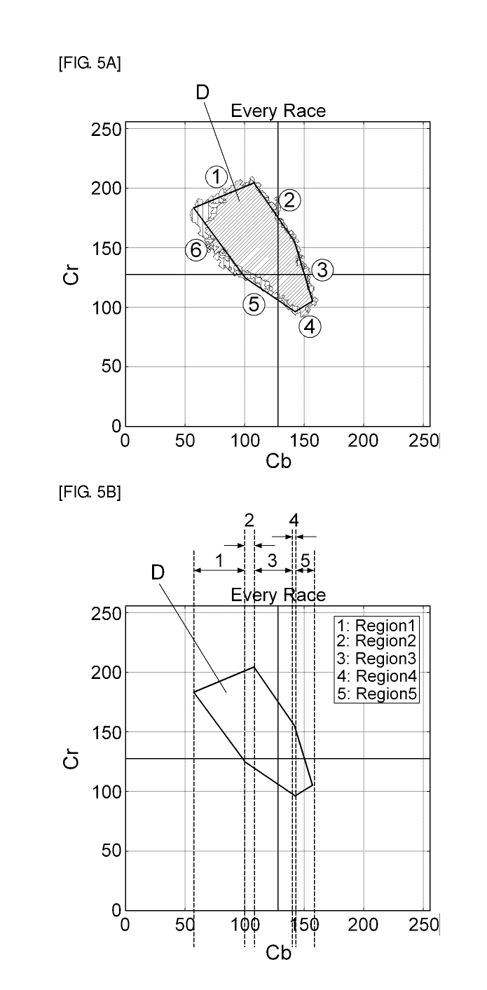

In this case, the first skin region storing section 311 stores the first skin region represented by the distribution of sampled human skins. As shown in FIG. 4D and FIGS. 5A and 5B, the first skin region indicates skin sample data D which is obtained by sampling human skins.

FIG. 4A is a distribution diagram representing black race sample data A, which is obtained by sampling the skins of the black race, as Cb and Cr components in a YCbCr color space. FIG. 4B is a distribution diagram representing yellow race sample data B, which is obtained by sampling the skins of the yellow race, as Cb and Cr components in the YCbCr color space. FIG. 4C is a distribution diagram representing white race sample data C, which is obtained by sampling the skins of the white race, as Cb and Cr components in the YCbCr color space. In the YCbCr color space, Y components represent luminance, and Cb and Cr components represent chrominance. Further, an image signal can be represented as data by using the Y, Cb, and Cr components.

As shown in FIG. 4D, all the skins of the black, yellow, and white races are collected so that skin sample data D, which indicates the skin color of every race, can be represented as Cb and Cr components in the color space. Then, the circumference of the skin sample data D is divided into 6 decision boundaries. FIGS. 5A and 5B are graphs showing the first skin region using the skin sample data.

The Cr component of each decision boundary can be expressed by Expression 1.

[Expression 1]

Cri=(slopeᵢ×Cb)+Yi

Here, i represents a variable indicating each decision boundary, and Yi represents a variable indicating a y-intercept of an i^{th} decision boundary.

All the Cr components of the first to sixth decision boundaries can be expressed by Expression 1.

Further, as shown in FIG. 5B, the skin sample data D is divided into five regions so as to be represented as Cb components of the color space. Then, the Cb components of the regions can be expressed by Expression 2.

[Expression 2]

First region: 58≦Cb1<101

Second region: 101≦Cb2<108

Third region: 108≦Cb3<141

Fourth region: 141≦Cb4<143

Fifth region: 143≦Cb5<157

In addition, the Cr components represented as 6 decision boundaries by Expression 1 can be represented as first to fifth regions by Expression 3.

[Expression 3]

First region: Cr6≦Cr1≦Cr1

Second region: Cr5≦Cr2≦Cr1
Third region: Cr5≦Cr3≦Cr2
Fourth region: Cr5≦Cr4≦Cr3
Fifth region: Cr4≦Cr5≦Cr3

As expressed in Expression 3, the Cr components are also converted into data such that the skin sample data D is converted into the first skin region. Then, it is possible to easily compare the image signal S with the first skin region D by judging whether or not the image signal S is included in the first skin region D which is skin sample data represented on the color space.

Therefore, the first skin region detecting section 312 compares the first skin region D, converted into data by the above-described method, with the image signal S so as to detect a region included in the first skin region D from the image signal S.

At this time, when a region included in the first skin region is detected from the image signal S, the image signal S is delivered to the second skin region detecting unit 320. Otherwise, when a region included in the first skin region is not detected from the image signal S, an image signal S′, which is obtained by processing the image signal S into a black color, is output, because it is judged that the first skin region is not included in the image signal S.

When the image signal S is processed into a black color, the Y, Cb, and Cr components of the image signal S are converted into 0, 128, and 128, respectively (Y=0, Cb=128, and Cr=128). Then, the output image signal S′ is output as a black color, thereby indicating that the first skin region is not included in the image signal S.

The second skin region detecting unit 320 includes a second skin region setting section 321 and a second skin region detecting section 322. The second skin region detecting unit 320 is connected to the first skin region detecting unit 310 and serves to detect a second skin region included in the image signal S in which the first skin region D is detected by the first skin region detecting unit 310.

The second skin region setting section 321 sets a second skin region for excluding a portion of the first skin region which overlaps clothes or objects having a very similar color to skin.

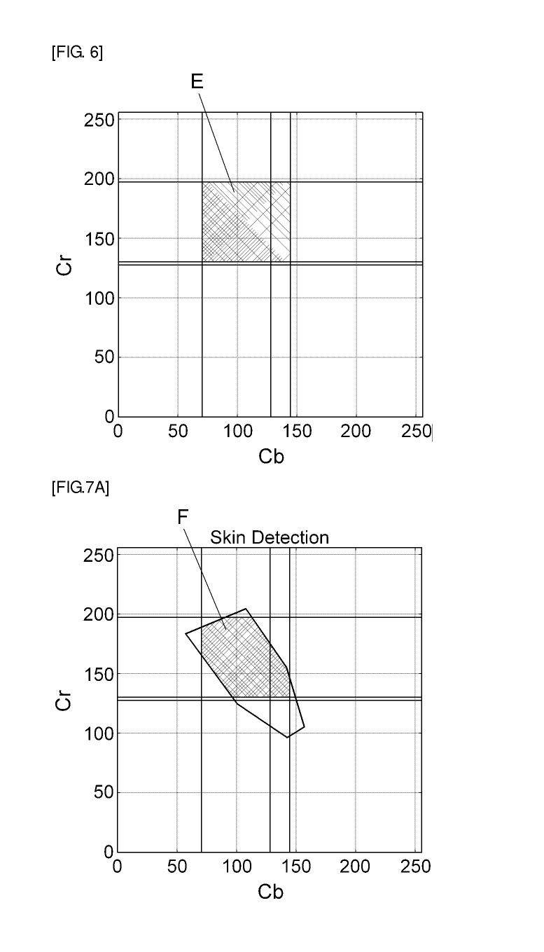

FIG. 6 is a diagram showing a second skin region E. As shown in FIG. 6, the second skin region E is formed in a rectangle and is composed of Cb and Cr components. The range of the second skin region E can be set by changing the upper and lower and right and left Cb and Cr components.

For example, options for the second skin region E can be set as four cases, as shown in Table 1.

TABLE 1

| | | | | |
|---|---|---|---|---|
| Second skin region | 1 | 2 | 3 | 4 |
| option | | | | |
| Option size | Smaller | Default | Larger | Largest |
| White region | 1 | 2 | 3 | 4 |
| processing option | | | | |
| Option size | Smallest | Smaller | Default | Larger |

The Cb and Cr components corresponding to the respective options of the second skin region E set in Table 1 can be set as shown in Table 2.

TABLE 2

| Parameter | Value | Option number | Option size |
|---|---|---|---|
| cb_left | 72 | 1 | Smaller |
| cb_right | 143 | | |
| cr_down | 132 | | |
| cr_up | 195 | | |
| cb_left | 70 | 2 | Default |
| cb_right | 145 | | |
| cr_down | 130 | | |
| cr_up | 197 | | |
| cb_left | 68 | 3 | Larger |
| cb_right | 147 | | |
| cr_down | 128 | | |
| cr_up | 199 | | |
| cb_left | 66 | 4 | Largest |
| cb_right | 149 | | |
| cr_down | 126 | | |
| cr_up | 201 | | |

Tables 1 and 2 show an embodiment of the invention. The number of options of the second skin region E and the Cb and Cr components corresponding to the respective options of the second skin region E can be changed depending on users.

The second skin region setting section 321 selects any one option from the options of the second skin region E shown in Table 1, and then sets the range of the second skin region E.

The second skin region detecting section 322 is connected to the second skin region setting section 321 and serves to compare the set second skin region E with the image signal S delivered from the first skin region detecting section 312 so as to detect the second skin region E included in the image signal S.

When it is detected that the second skin region E is included in the image signal S, the image signal S is delivered to the skin region processing unit 340.

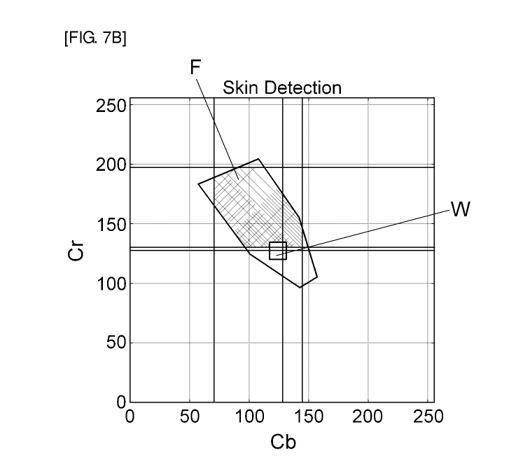

Otherwise, when it is not detected that the second skin region E is included in the image signal S, it is judged that the image signal S does not have a skin region F including both of the first and second skin regions D and E. Then, the image signal S is converted into a black color and is then output. FIG. 7A is a graph showing the skin region F including both of the first and second skin regions D and E. At this time, when the image signal S is converted into a black color, the Y, Cb, and Cr components of the image signal S are converted into 0, 128, and 128 (Y=0, Cb=128, and Cr=128). Then, the processed image signal S′ is output.

Meanwhile, a white region may be included in the skin region F detected by the second skin region detecting unit 320, because of a lighting of an imaging device or the like. When a white region is included in the skin region F, an image is slightly different from when the image is actually seen with eyes. Therefore, the image can be processed so as to be represented as the same image as that seen with eyes.

To represent the image signal S as the same image as that seen with eyes, the processing of the white region can be carried out. However, the processing of the white region depends on user's selection. Therefore, there should be provided a function of selecting whether or not to process a white region.

The white region processing unit 330 includes a white region setting section 331 and a white region processing section 332 and is provided between the second skin region detecting unit 320 and the skin region processing unit 340. The white region processing unit 330 serves to process a white region included in the detected skin region F of the image signal S.

The white region setting section 331 is connected to the white region processing section 332 and determines whether or not to process the white region of the detected skin region. Further, when it is determined that the white region is to be processed, an option for selecting the range of the white region W in the skin region F of FIG. 7B is selected. FIG. 7B is a graph showing the white region W. At this time, the option for selecting the range can be set as shown in Table 3.

TABLE 3

| Parameter | Value | Option number | Option size |
|---|---|---|---|
| white_cb_left | 119 | 1 | Smallest |
| white_cb_right | 129 | | |
| white_cr_down | 123 | | |
| white_cr_up | 133 | | |
| white_cb_left | 118 | 2 | Smaller |
| white_cb_right | 130 | | |
| white_cr_down | 122 | | |
| white_cr_up | 134 | | |
| white_cb_left | 117 | 3 | Default |
| white_cb_right | 131 | | |
| white_cr_down | 121 | | |
| white_cr_up | 135 | | |
| white_cb_left | 116 | 4 | Larger |
| white_cb_right | 132 | | |
| white_cr_down | 120 | | |
| white_cr_up | 136 | | |

As shown in Table 3, the white region W is a region of the skin region F where the skin is represented as a white color by light or the like. Therefore, the range of the white region W belongs to the skin region F, and the Cb and Cr components thereof are formed around about 128.

The white region processing section 332 is connected to the white region setting section 331 and the skin region processing unit 340 and serves to judge whether the white region W set by the white region setting section 331 is included in the skin region F of the image signal S or not. When the white region W is included in the skin region F, the white region processing section 332 processes the white region W into a black color. At this time, the Y, Cb, and Cr components of the white region W are converted into 0, 128, and 128, respectively (Y=0, Cb=128, and Cr=128).

Further, when the white region W is not included in the skin region F of the image signal S, and when the option for processing the white region W is not selected, the white region processing section 332 does not process the image signal S, but delivers the image signal S to the skin region processing unit 340.

The skin region processing unit 340 is connected to the white region processing unit 330 and receives the image signal S, in which the white region W is processed by the white region processing unit 330. Then, the skin region processing unit 340 outputs a region of the image signal S included in the skin region F, as it is, and processes the other region, excluding the region included in the skin region F, into a black color. Further, the skin region processing unit 340 outputs the processed image signal S′.

When the other region excluding the region of the image signal S included in the skin region F is processed into a black color, the Y, Cb, and Cr components of the other region are set to 0, 128, and 128, respectively (Y=0, Cb=128, and Cr=128).

In the image signal S′ processed in such a manner, the other region excluding the skin region F is processed into a black color such that only the skin region F representing a human skin can be extracted.

In the skin detection system according to the invention, all skin colors of black, yellow, and white races are collected and then represented as the first and second skin regions D and E serving as the skin sample data on the YCbCr color space. Therefore, the first and second skin regions D and E can be easily compared with the image signal S, which makes it possible to reduce the detection time of the first and second skin regions D and E.

Further, compared with the conventional system which detects a face contour while comparing an image signal with face contour sample data in which various types of face contours are stored, the storage space of the skin detection system according to the invention can be reduced, which makes it possible to reduce the size of the system.

Hereinafter, a skin detection method according to the invention will be described with reference to the accompanying drawings.

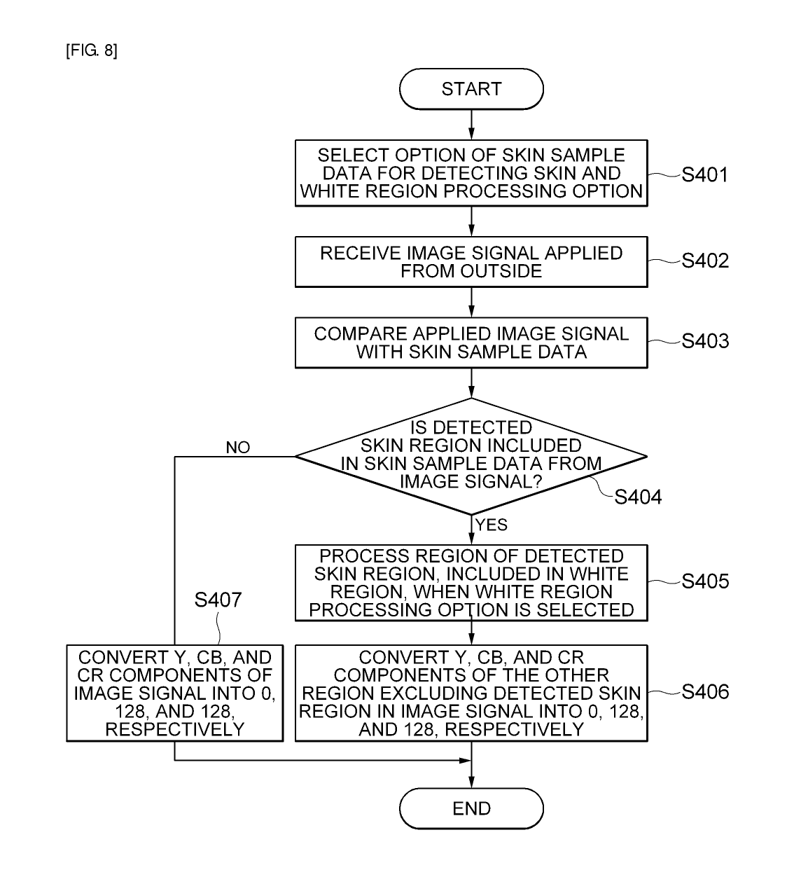

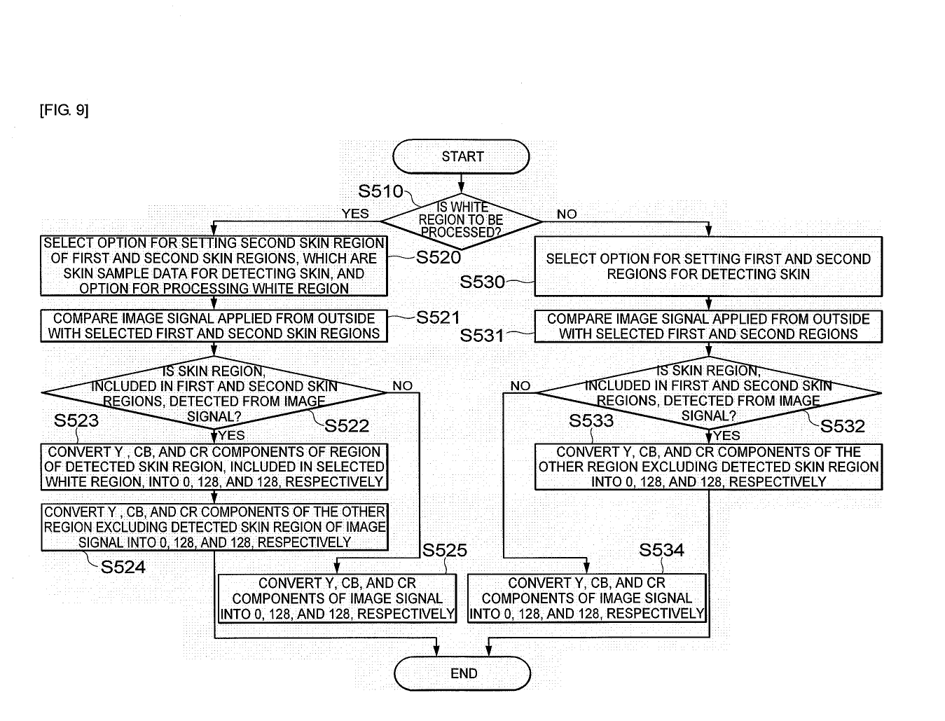

FIG. 8 is a flow chart sequentially showing a skin detection method according to the invention. FIG. 9 is a flow chart sequentially showing the skin detection method in more detail.

First, as shown in FIG. 8, an option of skin sample data for detecting a skin and a white region processing option are selected (step S401).

After the options are selected, an image signal is applied from outside (step S402).

Then, the applied image signal is compared with the skin sample data of step S401 (step S403).

Next, it is judged whether or not a skin region included in the skin sample data is detected from the compared image signal (step S404).

When it is judged at step S404 that the skin region included in the skin sample data is detected from the image signal, it is judged whether the white region processing option is selected or not. When the white region processing option is selected, a region of the detected skin region, included in the white region, is processed (step S405).

The Y, Cb, and Cr components of the region included in the white region or the Y, Cb, and Cr components of the other region excluding the detected skin region in the image signal, in which the white region is not processed because the white region processing option is not selected at step S405, are converted into 0, 128, and 128, respectively, and the image signal is output (step S406).

When it is judged at step S404 that a skin region included in the skin sample data is not detected from the image signal, the Y, Cb, and Cr components of the image signal are converted into 0, 128, and 128, respectively, and the image signal is output (step S407).

Referring to FIG. 9, the skin detection method according to the invention will be described in more detail.

First, as shown in FIG. 9, it is determined whether or not to process the white region included in the image signal (step S510).

When it is determined at step S510 that the white region is to be processed, an option for setting a second skin region of first and second skin regions, which are skin sample data for detecting a skin, and an option for processing the white region are selected (step S520).

At this time, the options in step S520 are previously set by a user, and the values of the options may be set depending on the necessity of the user.

After the options are selected in step S520, an image signal is applied from outside, and is then compared with the selected first and second skin regions (step S521).

A skin region included in the first and second skin regions is detected from the image signal (step S522).

When a skin region included in both of the first and second skin regions is detected from the image signal, a region of the detected skin region, included in the selected white region, is processed into a black color. When the region is processed into a black color, the Y, Cb, and Cr components of the region are converted into 0, 128, and 128, respectively (Y=0, Cb=128, and Cr=128) (step S523).

Then, the Y, Cb, and Cr components of the other region excluding the detected skin region of the image signal are converted into 0, 128, and 128, respectively (Y=0, Cb=128, and Cr=128), and the detected skin region is not processed, but is output as it is (step S524).

When the skin region included in both of the first and second skin regions is not detected from the image signal at step S522, the image signal is processed into a black color. At this time, the Y, Cb, and Cr components of the image signal are converted into 0, 128, and 128, respectively (Y=0, Cb=128, and Cr=128) (step S525).

Meanwhile, when it is determined at step S510 that the white region is not to be processed, an option for setting the first and second regions for detecting a skin is selected (step S530).

After the option is selected, an image signal is applied from outside and is then compared with the selected first and second regions (step S531).

Next, a skin region included in both of the first and second skin regions is detected from the image signal (step S532).

When a skin region included in both of the first and second skin regions is detected from the image signal at step 532, the other region excluding the detected skin region of the image signal is processed into a black color. When the other region is processed into a black color, the Y, Cb, and Cr components of the other region are converted into 0, 128, and 128, respectively (Y=0, Cb=128, and Cr=128) (step S533).

When the skin region included in both of the first and second skin regions is not detected from the image signal at step 532, the image signal is processed into a black color. That is, the Y, Cb, and Cr components of the image signal are set to 0, 128, and 128, respectively (Y=0, Cb=128, and Cr=128) (step S534).

As described above, a skin region included in the first and second skin regions is detected from the image signal. Further, the other region excluding the skin region is converted into a black color, and the skin region is output as it is. Therefore, it is possible to extract and output only the skin region representing a human skin.

According to the skin detection system and method, an image signal is compared with the skin region of the skin sample data using the YCbCr color space, which makes it possible to reduce the detection time of the skin region.

Further, since the skin sample data is data represented on the YCbCr color space, the volume thereof is so small that a storage space for storing the skin sample data is reduced, which makes it possible to reduce the size of the skin detection system.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A skin detection system comprising:
a first skin region detecting unit that detects a region included in a first skin region from an image signal applied from outside, the first skin region represented by the distribution of sampled human skins;
a second skin region detecting unit that detects a region included in a second skin region, where a human skin region is set, from the image signal; and
a skin region processing unit that, when a region included in both of the first and second skin regions is detected, determines the region as a human skin region so as to extract the detected skin region.

2. The skin detection system according to claim 1, wherein the first skin region detecting unit includes:
a first skin region storing section which stores the range of the first skin region; and
a first skin region detecting section which detects a region included in the first skin region from the image signal.

3. The skin detection system according to claim 2, wherein when a region included in the first skin region is not detected from the image signal, the first skin region detecting section processes the image signal into a black color and then outputs the processed image signal.

4. The skin detection system according to claim 2, wherein when a region included in the first skin region is not detected from the image signal, the first skin region detecting section converts the Y, Cb, and Cr components of the image signal into 0, 128, and 128, respectively, and then outputs the image signal.

5. The skin detection system according to claim 1, wherein the second skin region detecting unit includes:
a second skin region setting section which selects any one option from a plurality of options, in which the range of the second skin region is set in advance, and then sets the range of the second skin region; and
a second skin region detecting section which detects a region included in the set second skin region from the image signal.

6. The skin detection system according to claim 5, wherein when a region included in the second skin region is not detected from the image signal in which the first skin region is detected, the second skin region detecting section processes the image signal into a black color and then outputs the image signal.

7. The skin detection system according to claim 5, wherein when a region included in the second skin region is not detected from the image signal in which the first skin region is detected, the second skin region detecting section converts the Y, Cb, and Cr components of the image signal into 0, 128, and 128, respectively, and then outputs the image signal.

8. The skin detection system according to claim 1, wherein the skin region processing unit processes the other region excluding the detected skin region into a black color.

9. The skin detection system according to claim 1, wherein the skin region processing unit converts the Y, Cb, and Cr components of the other region excluding the detected skin region into 0, 128, and 128, respectively.

10. The skin detection system according to claim 1 further comprising:
a white region processing unit that is connected to the second skin region detecting unit and the skin region processing unit, and when the skin region is detected, processes a white region included in the detected skin region.

11. The skin detection system according to claim 10, wherein the white region processing unit includes:
a white region setting section which selects any one option among a plurality of options, in which the range of the white region is set in advance, so as to set the range of the white region; and
a white region processing section which processes a region of the detected skin region included in the white region.

12. The skin detection system according to claim 11, wherein when a region included in the white region is detected from the detected skin region, the white region processing section processes the detected white region into a black color.

13. The skin detection system according to claim 11, wherein when a region included in the white region is detected from the detected skin region, the white region processing section converts the Y, Cb, and Cr components of the detected white region into 0, 128, and 128, respectively.

14. A skin detection method comprising the steps of:
(a) selecting an option of skin sample data, which is obtained by sampling human skins, so as to detect a human skin;
(b) receiving an image signal from outside;
(c) comparing the image signal with the skin sample data; and
(d) when a skin region included in the skin sample data is detected from the compared image signal, extracting the detected skin region.

15. The skin detection method according to claim 14, wherein the skin sample data obtained by sampling human skins is composed of first and second skin regions.

16. The skin detection method according to claim 15, wherein in step (a), any one option among a plurality of options, where the range of the second skin region is set in advance, is selected so as to set the range of the second skin region.

17. The skin detection method according to claim 15, wherein when a region included in the first skin region is not detected from the image signal compared in step (c), the image signal is processed into a black color and is then output.

18. The skin detection method according to claim 15, wherein when a region included in the first skin region is not detected from the image signal compared in step (c), the Y, Cb, and Cr components of the image signal are converted into 0, 128, and 128, respectively, and then the image signal is output.

19. The skin detection method according to claim 15, wherein when a region included in the second skin region is not detected from the image signal compared in step (c), the image signal is processed into a black color and is then output.

20. The skin detection method according to claim 15, wherein when a region included in the second skin region is not detected from the image signal compared in step (c), the Y, Cb, and Cr components of the image signal are converted into 0, 128, and 128, respectively, and then the image signal is output.

21. The skin detection method according to claim 15, wherein when a skin region included in both of the first and second skin regions is detected from the image signal in step (d), the other region excluding the detected skin region is processed into a black color.

22. The skin detection method according to claim 15, wherein when a skin region included in both of the first and second skin regions is detected from the image signal in step (d), the Y, Cb, and Cr components of the other region excluding the detected skin region are converted into 0, 128, and 128, respectively.

23. The skin detection method according to claim 14 further comprising the step of:
setting a white region processing option for processing the white region of the skin region included in the skin sample data in step (a).

24. The skin detection method according to claim 23, wherein in step (a), any one option among a plurality of options, where the range of the white region is set in advance, is selected so as to set the range of the white region.

25. The skin detection method according to claim 23, wherein when the white region processing option is selected in step (a), the white region of the detected skin region is processed into a black color in step (d).

26. (canceled)
